(19) United States
(12) Patent Application Publication
(10) Pub. No.: US 2009/0129122 A1
(43) Pub. Date: May 21, 2009

(54) POWER SUPPLY DEVICE FOR ARC APPARATUS

(76) Inventors: Masahiro Ohashi, Osaka (JP); Takayuki Nishisako, Osaka (JP); Tetsuro Ikeda, Osaka (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 12/098,488

(22) Filed: Apr. 7, 2008

(30) Foreign Application Priority Data
Nov. 15, 2007 (JP) 2007-296463

(51) Int. Cl. H02M 3/335

(52) U.S. Cl. 363/17

(57) ABSTRACT

This power supply device for an arc apparatus includes: a three phase full wave rectification circuit in which a plurality of semiconductor switching elements are connected in inverse parallel with a plurality of rectification elements, and which rectifies a three phase AC power supply; an AC reactor which is connected to the three phase AC power supply and the three phase full wave rectification circuit; a smoothing capacitor which smoothes the output voltage of the three phase full wave rectification circuit; an inverter circuit which converts the output of the smoothing capacitor to high frequency AC; and a rectification circuit which rectifies the output of the inverter circuit and supplies the result to a load. Moreover, this power supply device for an arc apparatus also includes a control is circuit which performs switching control of the semiconductor switching elements, so that the phases of the input voltage and of the input current of the three phase AC power supply agree with one another.

### CROSS REFERENCE

This Nonprovisional application claims priority under 35 U.S.C. §119(a) on Patent Application No. 2007-296463 filed in Japan on Nov. 15, 2007, the entire contents of which are hereby incorporated by reference.

### BACKGROUND OF THE INVENTION

The present invention relates to a power supply device for an arc apparatus such as an arc welding machine or an arc fusion machine or the like.

In recent years, due to the increase of devices which generate harmonic components, such as inverter devices and the like, various bad influences have been exerted upon other electrical devices. Due to this, in various countries, harmonic current component regulations have been instituted which are classified according to the application or the input electrical power or the like. For example, in Europe, harmonic component standards are prescribed by IEC61000-3-2 and IEC61000-3-12, and in Japan harmonic component standards are prescribed by JIS C 61000-3-2:2005.

The subjects which are regulated according to this type of standard are not only household electrical devices, but naturally include also electrical devices for industrial use, such as welding machines and fusion machines and the like. Thus, with an electrical device for industrial use, in order to comply with such harmonic component regulations, it has been proposed to provide a PFC (Power Factor Correction) circuit to the power supply. For example, in U.S. Pat. No. 6,365,868, there is described a plasma cutting system in which harmonic current components are suppressed by adding a PFC circuit 35 to the power supply, as shown in FIG. 1.

However, while this system as described in the specification of U.S. Pat. No. 6,365,868 is one in which three phase AC electrical power is inputted from the commercial power supply, still the PFC only comprises one inductor, one switch, and one diode. Due to this, with this system, the waveform of the input current Iin with respect to that of the input voltage Vin is as shown in FIG. 2. Furthermore, the improved power factor is around 0.85˜0.9, and it is not possible to improve the power factor above that level.

The objective of the present invention is to provide a power supply device for an arc apparatus, which can further improve the power factor.

### SUMMARY OF THE INVENTION

In one embodiment of the power supply device for an arc apparatus according to the present invention, a plurality of semiconductor switching elements are connected in inverse parallel with a plurality of rectification elements of a three phase full wave rectification circuit, respectively, and, by performing switching control of these semiconductor switching elements, a control circuit makes the input voltage and the input current of each phase of a three phase AC power supply agree with one another.

Furthermore, in another embodiment of the power supply device for an arc apparatus according to the present invention, a plurality of semiconductor switching elements are connected in inverse parallel with at least two rectification elements of a single phase full wave rectification circuit, respectively, and, by performing switching control of these semiconductor switching elements, a control circuit makes the input voltage and the input current of a single phase AC power supply agree with one another.

With the structures described above, it becomes possible to shape the input current waveform and the input voltage waveform in an almost similar manner, so that it is possible to make the power factor be almost 1; and accordingly the power factor can be greatly improved over that of a device according to the prior art. Moreover, it is also possible to reduce the number of components, as compared to a prior art type power supply device for an arc apparatus.

### BRIEF DESCRIPTION OF THE DRAWINGS

FIG. 1 is a block diagram of a prior art electrical device which includes a PFC circuit;

FIG. 2 is a figure showing the input voltage waveform and the input current waveform of this prior art electrical device;

FIG. 3 is a structural diagram of a power supply device for an arc apparatus according to a first embodiment of the present invention;

FIG. 4A is a figure showing the input voltage waveform of the AC power supply;

FIG. 4B is a figure showing the waveform of a control signal for a switching element;

FIG. 4C is a figure showing the waveform of a control signal for another switching element;

FIG. 4D is a figure showing the input current waveform of the AC power supply;

FIG. 4E is a figure showing the input voltage and input current waveforms of the AC power supply together;

FIG. 5 is a structural diagram of a power supply device for an arc apparatus according to a second embodiment of the present invention; and

FIG. 6 is a structural diagram of a power supply device for an arc apparatus according to a variant of the second embodiment of the present invention.

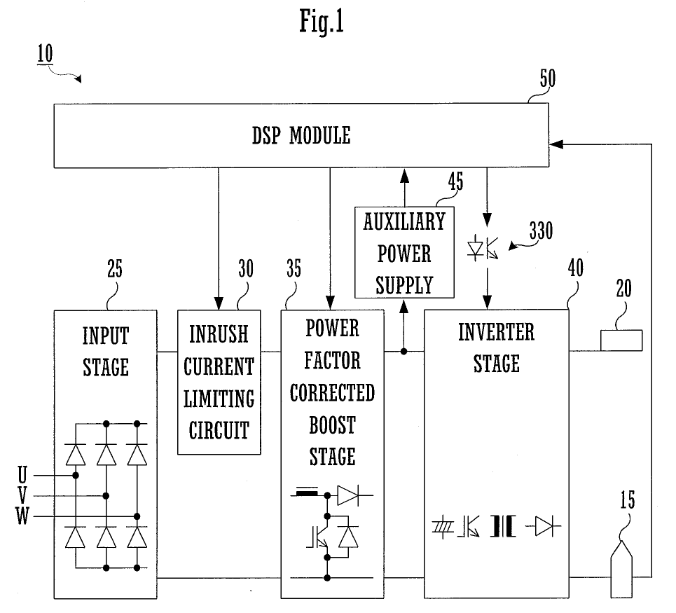

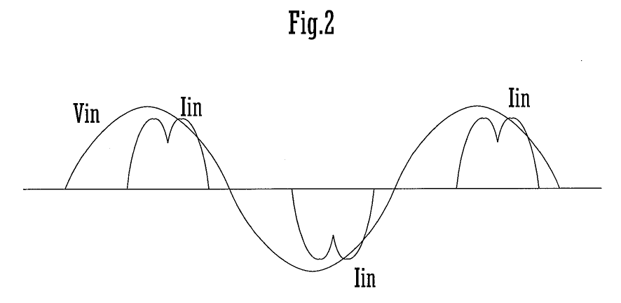

### DETAILED DESCRIPTION OF THE INVENTION

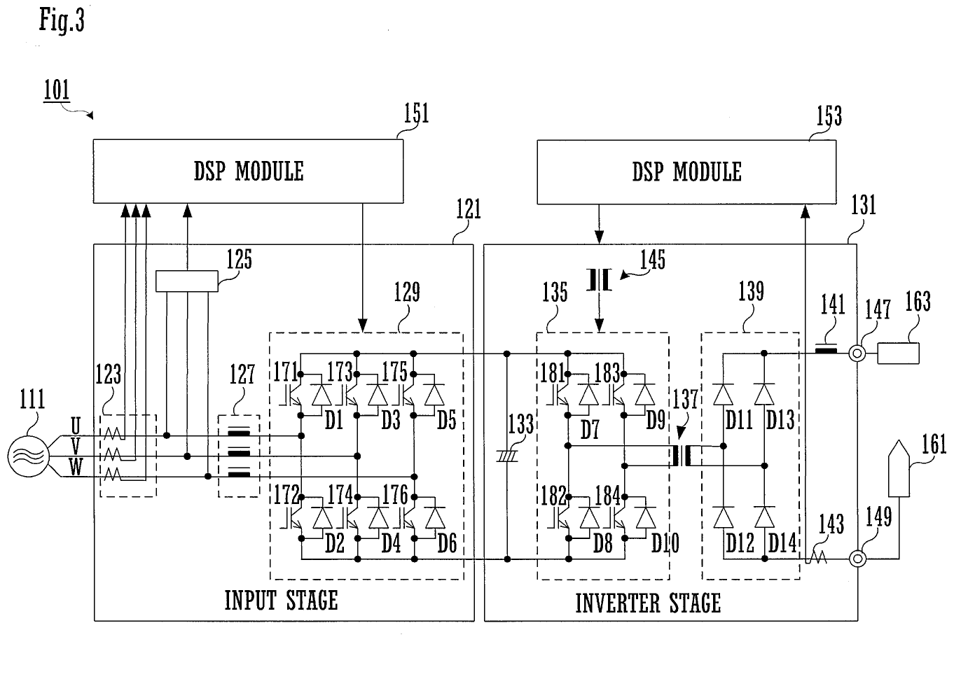

FIG. 3 is a structural diagram of a power supply device for an arc apparatus according to a first embodiment of the present invention. As shown in FIG. 3, this power supply device for an arc apparatus (hereinafter simply termed a “power supply device”) comprises an input stage 121, an inverter stage 131, and DSP modules 151 and 153, and supplies power to a torch 161 which acts upon a workpiece 163.

The input stage 121 comprises a line current detector 123, a phase voltage detector 125, an AC reactor (hereinafter simply termed a “reactor”) 127, and a three phase full wave rectification circuit 129.

The line current detector 123 detects the line current of each phase of the three phase AC power supply, and outputs a value corresponding to each line current to the DSP module 151. It should be understood that although, in FIG. 3, the line current detector is provided to each of the phases U, V, and W, it would also be acceptable to provide the line current detector only to, for example, the U phase and the W phase. In this case, the line current in the V phase could be obtained by calculation from the line currents in the U phase and in the W phase.

The phase voltage detector 125 detects the voltage of each phase of the three phase AC power supply, and outputs a value corresponding to each phase voltage to the DSP module 151. By providing the line current detector 123 and the phase voltage detector 125, it is possible reliably to ascertain the states of the input voltages and of the input currents.

The DSP module 151 outputs control signals for performing switching control to IGBTs (Insulated Gate Bipolar Transistors) 171 through 176 of the three phase full wave rectification circuit 129, based upon the line currents of the various phases detected by the line current detector 123 and the phase voltages of the various phases detected by the phase voltage detector 125.

The reactor 127 accumulates energy for charging a smoothing capacitor 133.

The three phase full wave rectification circuit 129 comprises six diodes (rectification elements) D1 through D6 and the six IGBTs (semiconductor switching elements) 171 through 176. The six diodes D1 through D6 are connected in a full bridge layout, and the IGBTs 171 through 176 are connected to them each respectively, in inverse parallel. By connecting the diodes and the IGBTs in inverse parallel, accumulation of energy in the reactor 127, and charging up of the capacitor 133 using this energy, can be simply performed, as will be described hereinafter. The switching operations of these IGBTs 171 through 176 are controlled by the DSP module 151. These IGBTs can be turned ON and OFF by an input signal and are of the self arc-extinguishing type, and they can switch high power at high speed, since they are able to switch at higher speed than other switching elements such as power transistors and so on. The three phase full wave rectification circuit 129 has the function of rectifying the AC current from the three phase AC power supply U, V, W to DC current, and the function of improving the power factor.

The inverter stage 131 comprises a smoothing capacitor (hereinafter simply termed a “capacitor”) 133, an inverter circuit 135, a high frequency transformer 137, a full wave rectification circuit 139, a smoothing reactor 141, a current detector 143, and a pulse transformer 145.

The capacitor 133 smoothes the voltage which has been rectified by the input stage 121.

The inverter circuit 135 comprises four diodes (rectification elements) D7 through D10 and four IGBTs (semiconductor switching elements) 181 through 184. The four diodes D7 through D10 are connected together in a full bridge layout, and the IGBTs 181 through 184 are connected to them each respectively, in inverse parallel. The switching operations of the IGBTs 181 through 184 are controlled by the DSP module 153, via the pulse transformer 145. The inverter circuit 135 converts the DC voltage to AC voltage at a high frequency of, for example, from 20 kHz to 100 kHz.

The high frequency transformer 137 changes the voltage of the high frequency voltage generated by the inverter circuit 135. The high frequency transformer 137 may change the voltage of the high frequency AC voltage which has been converted by the inverter circuit 135 to, for example, 60 V, although this may vary according to the load of the arc device.

The full wave rectification circuit 139 comprises four diodes D11 through D14 which are connected in a full bridge layout. This full wave rectification circuit 139 full wave rectifies the high frequency AC voltage whose voltage level has been changed by the high frequency transformer 137. The cathodes of the diodes D12 and D14 of the full wave rectification circuit 193 are connected to a negative output terminal 149.

The smoothing reactor 141 smoothes the high frequency voltage which has been full wave rectified. This smoothing reactor 141 is connected to a positive output terminal 147.

The workpiece 163 is connected to the positive output terminal 147.

The torch 161 is connected to the negative output terminal 149.

The high frequency voltage which has been full wave rectified by the full wave rectification circuit 139 is smoothed by the smoothing reactor 141, and is then supplied to the torch 161 and the workpiece 163.

The current detector 143 detects the current that flows between the torch 161 and the workpiece 163, and outputs a signal corresponding to this current to the DSP module 153.

The DSP module 153 outputs a control signal corresponding to the signal outputted by the current detector 143 to the inverter circuit 135, via the pulse transformer 145. And the DSP module 153 controls the switching operations of the IGBTs 181 through 184 of the inverter circuit 135 with this control signal.

The power supply device 101 has the structure as described above, and, by employing it, the user is able to perform arc welding or arc fusion using the torch 161 and the workpiece 163.

Next, the special characteristics of this power supply device 101 with regard to improvement of the power factor will be explained. The DSP module 151 of the power supply device 101 detects the line current and the phase voltage of each of the phases U, V, and W of the three phase AC power supply with the line current detector 123 and the phase voltage detector 125. And the DSP module 151 outputs control signals to the IGBTs 171 through 176 of the three phase full wave rectification circuit 129 and performs switching control thereof (pulse width modulation—PWM), and, along with making the line current of each phase U, V, and W of the three phase AC power supply agree with the phase of the phase voltage, also controls the output voltage to be a constant voltage.

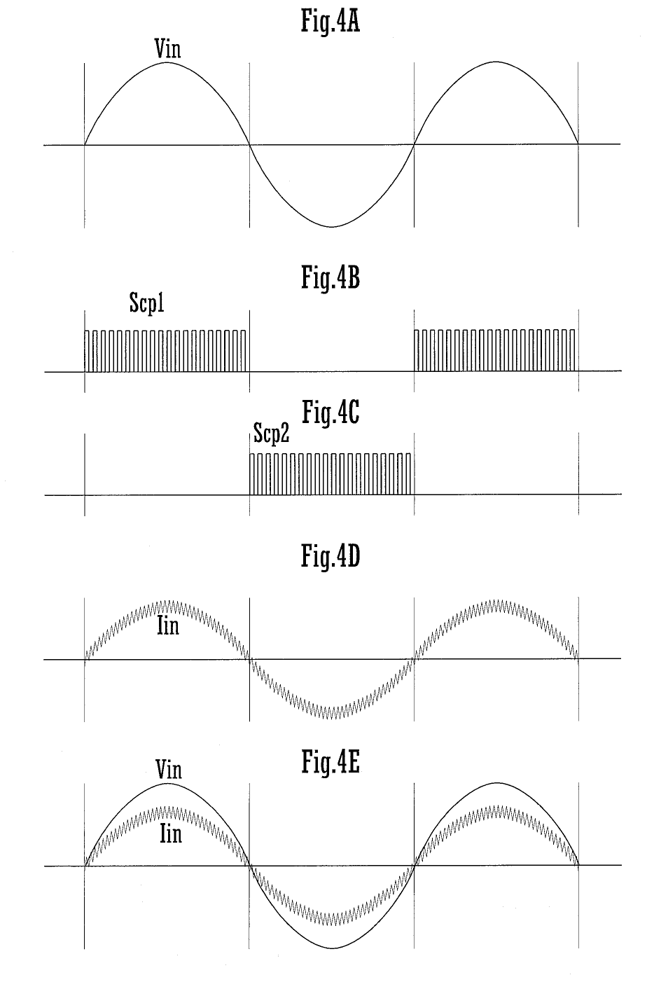

In concrete terms, control of each of the phases of the three phase AC power supply 111 is performed by the power supply device 101 in the following manner. FIG. 4A is a figure showing the input voltage waveform of the AC power supply; FIGS. 4B and 4C are figures showing the waveform of the control signals for the switching elements, FIG. 4D is a figure showing the input current waveform of the AC power supply, and FIG. 4E is a waveform showing the input voltage and the input current of the AC power supply together.

The following explanation takes the U phase of the three phase AC power supply as an example. The DSP module 151 detects the phase voltage of the U phase of the three phase AC power supply 111 with the phase voltage detector 125, and detects the line current of the U phase with the line current detector 123. And, when as shown in FIG. 4A the polarity of the U phase voltage of the three phase AC power supply 111 is positive, the DSP module 151 outputs a control signal (a chopper signal) Scp1 to the IGBT 172 on the lower side, as shown in FIG. 4B, and repeatedly turns this IGBT 172 ON and OFF at a predetermined frequency.

When the IGBT 172 is ON, then current flows in the path through the reactor 127, the IGBT 172, and the diodes D4 and D6, and induction energy is accumulated in the reactor 127. Furthermore, when the IGBT 172 is OFF, then an induced current due to the energy which has been accumulated in the reactor 127 flows to the capacitor 133 via the diode D1, and the capacitor 133 is charged up. Accordingly, it is possible freely to change this induction energy by appropriately controlling the periods during which the IGBT 172 is turned ON and OFF. Moreover, by exerting control so that the time period that the IGBT 172 is ON is longer than the time period that it is OFF, it is possible to raise the voltage across the capacitor 133 to be higher than the power supply voltage. For example, for an input voltage V1 of the three phase AC power supply 111 which is a nominal 220 V, the voltage V2 up to which the capacitor 133 is charged can be made to be a maximum of around 380 V.

On the other hand, when as shown in FIG. 4A the polarity of the U phase voltage of the three phase AC power supply 111 is negative, then the DSP module 151 outputs a control signal (a chopper signal) Scp2 to the IGBT 171 on the upper side, as shown in FIG. 4C, and repeatedly turns this IGBT 171 ON and OFF at a predetermined frequency. When the IGBT 171 is ON, then current flows in the path through the diodes D3 and D5, the IGBT 171, and the reactor 127, and induction energy is accumulated in the reactor 127. Furthermore, when the IGBT 171 is OFF, then an induced current due to the energy which has been accumulated in the reactor 127 flows to the capacitor 133 via the diodes D3 and D5, and the capacitor 133 is charged up.

Accordingly, by appropriately controlling the periods during which the IGBTs 171 and 172 are turned ON and OFF as described above, the DSP module 151 is able to shape the waveforms of the input current Iin and the input voltage Vin to sine wave like waveforms which are in phase, as shown in FIG. 4D.

Moreover, if the duty ratio at which the IGBTs 171 and 172 are turned ON and OFF is not fixed, but is controlled variably according to the voltage waveform of the power supply, then, along with being able to suppress fluctuations of the current waveform, it is also possible to make the shape of the current waveform further approximate to the shape of the voltage waveform.

In this manner, with the power supply device 101 of the present invention, along with it being possible to make the phase of the line current Iin of each of the phases U, V, and W of the three phase AC power supply ill and the phase of the phase voltage Vin agree with one another, as shown in FIG. 4E, also it is possible to make the power factor almost equal to 1, since it is possible to control the output voltage to be a constant voltage.

Moreover, with the power supply device 101 of the present invention, it is possible to make the device compact, since it is possible to reduce the number of component parts, as compared with a prior art power supply device for an arc apparatus. Furthermore, since the number of components is reduced, the reliability can be enhanced. Yet further, by this all digital control, output fluctuations due to temperature drift can also be decreased. Still further, due to standardization of the control circuitry, it is possible to shorten the development time period, and to enhance the reliability.

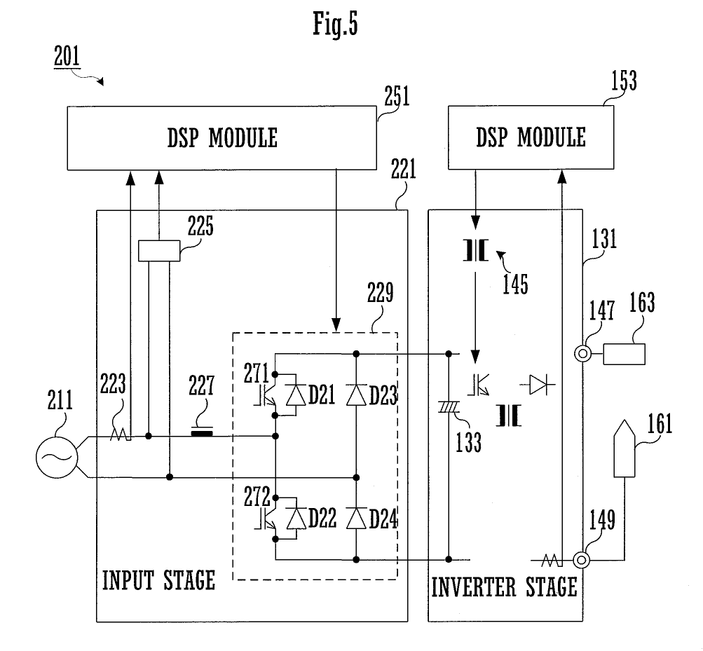

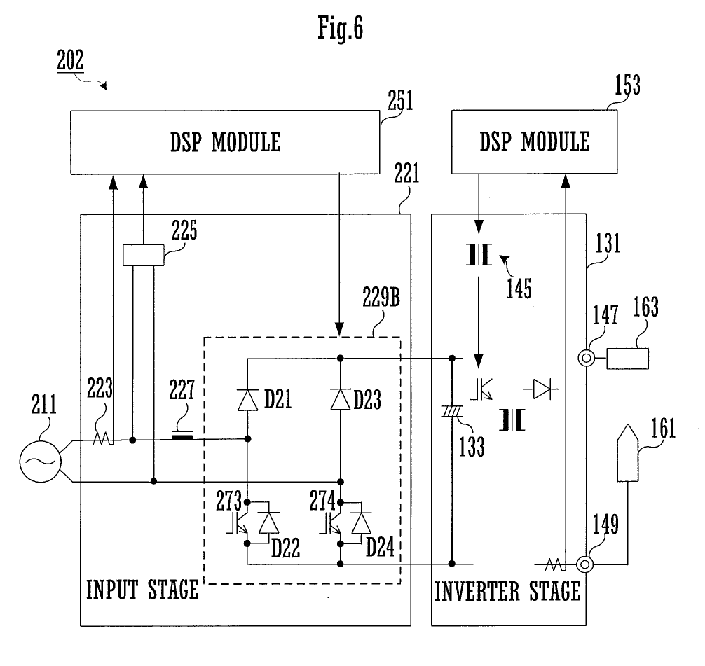

Next, the present invention can also be applied to a power supply device which is connected to the single phase AC power supply. FIG. 5 is a structural diagram showing a power supply device for an arc apparatus according to this second embodiment of the present invention. And FIG. 6 is a structural diagram showing a variant embodiment of this power supply device for an arc apparatus according to the second embodiment of the present invention.

As shown in FIG. 5, the power supply device 201 comprises an input stage 221, an inverter stage 131, and DSP modules 251 and 153, and supplies power to a torch 161 which acts upon a workpiece 163.

The input stage 221 comprises a line current detector 223, a phase voltage detector 225, an AC reactor 227, and a single phase full wave rectification circuit 229.

The line current detector 223 detects the line current of the single phase AC power supply 211, and outputs a value corresponding to the line current to the DSP module 251.

The phase voltage detector 225 detects the voltage of the single phase AC power supply 211, and outputs a value corresponding to this phase voltage to the DSP module 251. By providing the line current detector 223 and the phase voltage detector 225, it is possible reliably to ascertain the states of the input voltage and of the input current.

The AC reactor 227 accumulates energy for charging a capacitor 133.

The single phase full wave rectification circuit 229 comprises four diodes (rectification elements) D21 through D24 which are connected in a full bridge layout, and two IGBTs (semiconductor switching elements) 271 and 272 which are connected to the diodes D21 and D22 respectively, in inverse parallel. The switching operations of the IGBTs 271 and 272 are controlled by the DSP module 251. This single phase full wave rectification circuit 229 has the function of rectifying the AC current from the single phase AC power supply to DC current, and the function of improving the power factor.

The inverter stage 131 has the same structure as the inverter stage 131 of the power supply device 101 shown in FIG. 3, and the DSP module 153 controls this inverter stage 131 so as to perform the operation as explained with reference to FIG. 3. Although the detailed structure of this inverter stage 131 is omitted from the figure, it comprises the capacitor 133, an inverter circuit 135, a high frequency transformer 137, a full wave rectification circuit 139, a smoothing reactor 141, a current detector 143, and a pulse transformer 145.

Moreover, just as in the case of the power supply device 101, the workpiece 163 is connected to a positive output terminal 147 of the inverter stage 131, and the torch 161 is connected to a negative output terminal 149 of the inverter stage 131.

The power supply device 201 has the structure as described above, and, by employing it, the user is able to perform arc welding or arc fusion using the torch 161 and the workpiece 163.

Next, the special characteristics of this power supply device 201 with regard to improvement of the power factor will be explained. The DSP module 251 of the power supply device 201 detects the line current Iin and the phase voltage Vin of the single phase AC power supply with the line current detector 223 and the phase voltage detector 225. And the DSP module 251 outputs control signals to the IGBTs 271 and 272 of the single to phase full wave rectification circuit 229 and performs switching control thereof (pulse width modulation—PWM), and, along with making the line current Iin of the single phase AC power supply 211 agree with the phase of the phase voltage Vin, also controls the output voltage to be a constant voltage.

In concrete terms, the DSP module 251 of this power supply device 201 detects the phase voltage of the single phase AC power supply 211 with the phase voltage detector 225, and detects the line current thereof with the line current detector 223. As shown in FIG. 4A, when the polarity of the phase voltage of the single phase AC power supply 211 is positive, then the DSP module 251 outputs a control signal (a chopper signal) Scp1 to the IGBT 272 on the lower side, and turns this IGBT 272 ON and OFF at a predetermined frequency, as shown in FIG. 4B. When the IGBT 272 is ON, then current flows in the path through the reactor 227, the IGBT 272, and the diode D24, and induction energy is accumulated in the reactor 227. Furthermore, when the IGBT 272 is OFF, then an induced current due to the energy which has been accumulated in the reactor 227 flows to the capacitor 133 via the diode D21, and the capacitor 133 is charged up. Due to this charging current, the voltage across the capacitor 133 becomes higher than the power supply voltage.

On the other hand, when as shown in FIG. 4A the polarity of the phase voltage of the single phase AC power supply 211 is negative, then the DSP module 251 outputs a control signal (a chopper signal) Scp2 to the IGBT 271 on the upper side, as shown in FIG. 4C, and repeatedly turns this IGBT 271 ON and OFF at a predetermined frequency. When the IGBT 271 is ON, then current flows in the path through the diodes D23, the IGBT 271, and the reactor 227, and induction energy is accumulated in the reactor 227. Furthermore, when the IGBT 271 is OFF, then an induced current due to the energy which has been accumulated in the reactor 227 flows to the capacitor 133 via the diodes D21, and the capacitor 133 is charged up. Due to this charging current, the voltage across the capacitor 133 becomes higher than the power supply voltage.

Accordingly, by this type of operation, as shown in FIG. 4D, the waveform of the current Iin which flows to the capacitor 133 becomes almost analogous to the voltage waveform of the AC power supply. Moreover, if the duty ratio at which the IGBTs 271 and 272 are turned ON and OFF is not fixed, but is controlled variably according to the voltage waveform of the power supply, then, along with being able to suppress fluctuations of the current waveform, it is also possible to make the shape of the current waveform further approximate to the shape of the voltage waveform.

In this manner, with the power supply device 201 of the present invention, along with it being possible to make the phase of the line current Tin of the single phase AC power supply 211 and the phase of its phase voltage Vin agree with one another, as shown in FIG. 4E, it is also possible to make the power factor almost equal to 1, since it is possible to control the output voltage to be a constant voltage.

In the input stage of the single phase full wave rectification circuit 229 shown in FIG. 5, it would also be possible to connect the IGBTs in inverse parallel with respect to the diodes D22 and D24, as in the single phase full wave rectification circuit 229B shown in FIG. 6.

With the structure shown in FIG. 6 as well, in a similar manner to the case with the structure shown in FIG. 5, along with it being possible to make the phase of the line current of the single phase AC power supply and the phase of its phase voltage agree with one another, it is also possible to make the power factor almost equal to 1, since it is possible to control the output voltage to be a constant voltage.

It should be understood that, with the power supply devices 201 and 202 shown in FIGS. 5 and 6, although it has been shown by way of example that the IGBTs, which are switching elements, are connected in inverse parallel to the two diodes of the single phase full wave rectification circuit, this should not be considered as being limitative of the present invention; if the switching elements are connected in inverse parallel to at least two among the four diodes which make up the single phase full wave rectification circuit, then, along with it being possible to make the phase of the line current of the single phase AC power supply and the phase of its phase voltage agree with one another, it is also possible to control the output voltage to be a constant voltage.

It should be understood that, in the above described explanation of embodiments of the present invention, all of the features are shown by way of example, and should not be considered as being limitative of the present invention. The scope of the present invention is not to be defined by any of the features of the embodiment described above, but only by the scope of the appended Claims. Moreover, equivalents to elements in the Claims, and variations within their legitimate and proper scope, are also to be considered as being included within the range of the present invention.

What is claimed is:

1. A power supply device for an arc apparatus, comprising:
a three phase full wave rectification circuit in which a plurality of semiconductor switching elements are connected in inverse parallel with a plurality of rectification elements, respectively, and which rectifies a three phase AC power supply;
an AC reactor which is connected to said three phase AC power supply and said three phase full wave rectification circuit;
a smoothing capacitor which smoothes the output voltage of said three phase full wave rectification circuit; an inverter circuit which converts the output of said smoothing capacitor to high frequency AC;
a rectification circuit which rectifies the output of said inverter circuit and supplies the result to a load; and
a control circuit which performs switching control of said semiconductor switching elements, so that the phases of the input voltage and of the input current of said three phase AC power supply agree with one another.

2. A power supply device for an arc apparatus according to claim 1, wherein said control circuit repeats processing to accumulate energy in said AC reactor when said semiconductor switching elements are ON, and to charge up said smoothing capacitor with energy accumulated in said AC reactor when said semiconductor switching elements are OFF, and thereby makes the phases of the input voltage and of the input current agree with one another.

3. A power supply device for an arc apparatus according to claim 1, further comprising:
a phase voltage detection unit which detects the phase voltage of each phase of said three phase AC power supply; and a line current detection unit which detects the line current of each phase of said three phase AC power supply;
and wherein said control circuit performs switching control of said semiconductor switching elements, based upon the phase voltages and the line currents of each phase, detected by said phase voltage detection unit and said line current detection unit.

4. A power supply device for an arc apparatus according to claim 1, wherein said rectification elements are diodes, and said semiconductor switching elements are IGBTs.

5. A power supply device for an arc apparatus, comprising:
a single phase full wave rectification circuit in which a plurality of semiconductor switching elements are connected in inverse parallel with at least two rectification elements, respectively, and which rectifies a single phase AC power supply;
an AC reactor which is connected to said single phase AC power supply and said single phase full wave rectification circuit;
a smoothing capacitor which smoothes the output voltage of said single phase full wave rectification circuit; an inverter circuit which converts the output of said smoothing capacitor to high frequency AC;
a rectification circuit which rectifies the output of said inverter circuit and supplies the result to a load; and
a control circuit which performs switching control of said semiconductor switching elements, so that the phases of the input voltage and of the input current of said single phase AC power supply agree with one another.

6. A power supply device for an arc apparatus according to claim 5, wherein said control circuit repeats processing to accumulate energy in said AC reactor when said semiconductor switching elements are ON, and to charge up said smoothing capacitor with energy accumulated in said AC reactor when said semiconductor switching elements are OFF, and thereby makes the phases of the input voltage and of the input current agree with one another.

7. A power supply device for an arc apparatus according to claim 5, wherein said rectification elements are diodes, and said semiconductor switching elements are IGBTS.
